(19) United States
(12) Patent Application Publication
(10) Pub. No.: US 2012/0025705 A1
(43) Pub. Date: Feb. 2, 2012

(54) LED BULB

(76) Inventor: Man-Tsu Chang, Hsinchu City (TW)

(21) Appl. No.: 13/189,754

(22) Filed: Jul. 25, 2011

(30) Foreign Application Priority Data
Jul. 28, 2010 (TW) 099124903

(51) Int. Cl. H01K 1/62

(52) U.S. Cl. 315/32

(57) ABSTRACT

An LED bulb includes a bulb head, a bulb body mounted on the bulb head, and a heat dissipation seat connected to the bulb head, disposed within the bulb body, and defining a receiving space. A control circuit unit is disposed in the receiving space, and is connected electrically to the bulb head. An LED module is connected to and is disposed externally of the heat dissipation seat, and is connected electrically to the control circuit unit.

### CROSS-REFERENCE TO RELATED APPLICATION

This application claims priority of Taiwanese Application No. 099124903, filed on Jul. 28, 2010.

### BACKGROUND OF THE INVENTION

1. Field of the Invention

This invention relates to a bulb, and more particularly to a light-emitting diode (LED) bulb.

2. Description of the Related Art

A conventional light-emitting diode (LED) bulb, as disclosed in Taiwanese Patent No. M383673, has a plurality of light-emitting diode (LED) chips mounted on two circuit boards that are arranged in an intersecting manner. The LED chips are connected in series. The front and rear sides of each circuit board are fixed with the light-emitting diode chips. A bulb body of the LED bulb is filled with mixed gas for heat conduction. However, the heat dissipation of the conventional LED bulb through heat conduction using mixed gas is not only slow, but the effect is also limited. Thus, the temperature of the conventional LED is high, and is likely to scald a user's hand when accidentally touched by the user. Further, light emitted from the light-emitting diode chips is interfered by the circuit boards, so that the light cannot be effectively transmitted outwardly.

To resolve the aforesaid heat dissipation problem, another conventional LED bulb further includes a heat dissipation seat installed between the bulb head and the light-emitting diode chip, after which the bulb body is mounted on the heat dissipation seat. However, since the heat dissipation seat is exposed externally of the LED bulb, it is likely that the user may accidentally touch the heat dissipation seat and scald his/her hand.

### SUMMARY OF THE INVENTION

Therefore, an object of the present invention is to provide a light-emitting diode (LED) bulb that is capable of overcoming the aforementioned drawbacks of the prior art.

According to this invention, an LED bulb comprises a bulb head, a bulb body mounted on the bulb head, a heat dissipation seat connected to the bulb head and disposed within the bulb body, a control circuit unit, and an LED module. The heat dissipation seat defines a receiving space. The control circuit unit is disposed in the receiving space, and is connected electrically to the bulb head. The LED module is connected to and is disposed externally of the heat dissipation seat, and is connected electrically to the control circuit unit.

The efficiency of the present invention resides in that by mounting the heat dissipation seat on the bulb head, a major portion of heat generated by the LED bulb of the present invention can be transmitted to the bulb head, and the remaining portion of heat can be transmitted to the bulb body through heat radiation. Hence, there are two heat dissipating paths. Further, the heat dissipation seat is disposed within the bulb body, so that the problem of accidental touching of the heat dissipation seat by a user that causes scalding to the user's hand can be resolved.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of an LED bulb according to the first preferred embodiment of the present invention;

FIG. 2 is a perspective view of the first preferred embodiment in an assembled state;

FIG. 3 is an exploded perspective view of an LED bulb according to the second preferred embodiment of the present invention; and

FIG. 4 is a perspective view of the second preferred embodiment in an assembled state.

### DETAILED DESCRIPTION OF THE PREFERRED EMBODIMENTS

The above-mentioned and other technical contents, features, and effects of this invention will be clearly presented from the following detailed description of two preferred embodiments in coordination with the reference drawings.

Before this invention is described in detail, it should be noted that, in the following description, similar elements are designated by the same reference numerals.

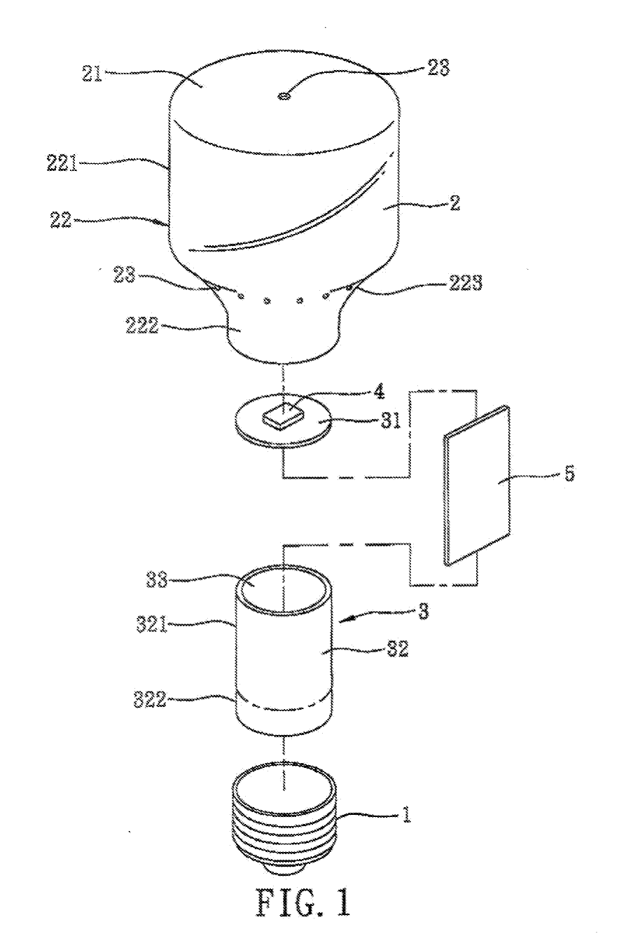

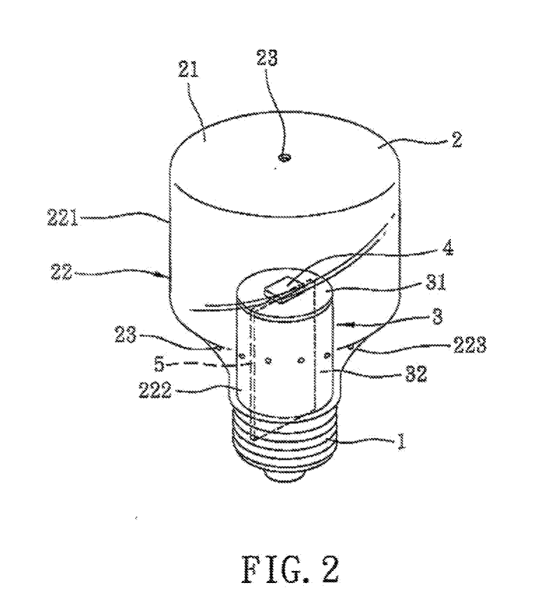

Referring to FIGS. 1 and 2, a light-emitting diode (LED) bulb according to the first preferred embodiment of the present invention comprises a bulb head 1, a bulb body 2, a heat dissipation seat 3, an LED module 4, and a control circuit unit 5.

The bulb body 2 includes a top wall 21, and a surrounding wall 22 having a wide section 221 extending downwardly from the top wall 21, a narrow section 222 opposite to the top wall 21 and connected to a top end of the bulb head 1 in a conventional manner, and a shoulder 223 connected between the wide and narrow sections 221, 222. The bulb body 2 further includes a plurality of convection holes 23 formed in and extending through the top wall 21 and the shoulder 223.

The heat dissipation seat 3 is disposed within the bulb body 2, and includes a top mounting plate 31, and a tubular surrounding wall 32 extending downward from an outer periphery of the top mounting plate 31. The top mounting plate 31 and the surrounding wall 32 cooperatively define a receiving space 33. In this embodiment, the surrounding wall 32 has an upper section 321, and a lower section 322 inserted press-fittingly into the top end of the bulb head 1 so that heat may be transmitted to the bulb head 1. The top mounting plate 31 is welded to a top end of the upper section 321. The lower section 322 is an aluminum oxide (Al₂O₃) insulating section.

The LED module 4 is disposed externally of the heat dissipation seat 3, and is mounted fixedly on the top mounting plate 31, such as by gluing.

The control circuit unit 5 is disposed in the receiving space 33 of the heat dissipation seat 3, and is attached fixedly to an inner surface of the surrounding wall 32 and to the bulb head 1 by using a thermally conductive, electrically insulating adhesive. As such, heat generated by the control circuit unit 5 can be transmitted to the heat dissipation seat 3, and the control circuit unit 5 can operate smoothly. The control circuit unit 5 is connected electrically to the bulb head 1 and the LED module 4 to control the power of the LED module 4 and to adjust the brightness of the LED module 4. In this embodiment, the power can be adjusted in the range between 3 to 8 watts. Generally, the brightness emitted from the LED module with a power of 5 watts is equivalent to a 60-watt incandescent lamp.

From the aforesaid description, it is apparent that heat generated by the LED bulb of the present invention not only can be dissipated to the atmosphere through the bulb body 2, but also can be dissipated from the heat dissipation seat 3 to the bulb head 1. Hence, the present invention has two heat dissipating paths. Further, the heat dissipation seat 3 is disposed within the bulb body 2, and is not exposed externally of the LED bulb, so that accidental touching of the heat dissipation seat 3 by the user can be prevented.

Moreover, the heat dissipation seat 3 of the present invention is made of aluminum, and is formed by stamping a flat aluminum plate. Thus, a pure aluminum material may be used instead of an aluminum alloy one. As compared to a heat dissipation seat that is made by press-forming an aluminum alloy material or extruding an aluminum material, the heat dissipation seat 3 formed by stamping a flat aluminum plate can enhance heat dissipation efficiency by 20 to 40%.

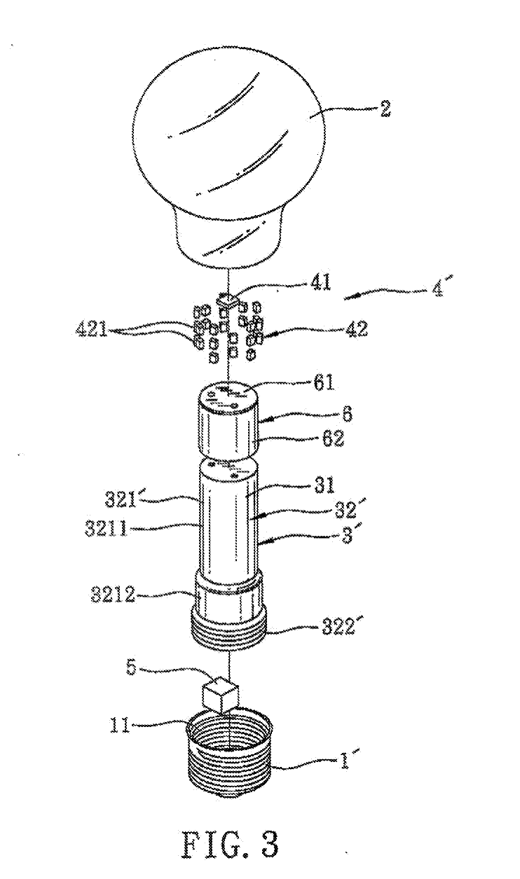

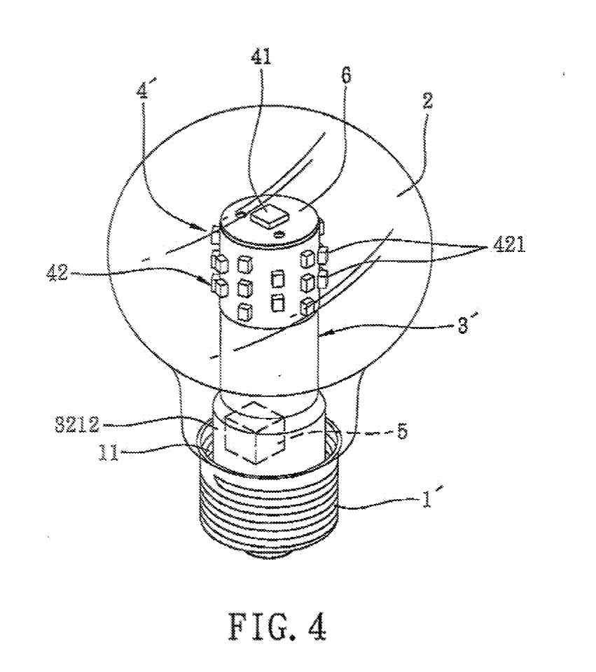

Referring to FIGS. 3 and 4, an LED bulb according to the second preferred embodiment of the present invention is shown to be similar to the first preferred embodiment. However, in this embodiment, the surrounding wall 32′ of the heat dissipation seat 3′ has a cylindrical stepped structure, and includes an aluminum oxide insulating lower section 322′ having an external thread, and an upper section 321′ opposite to the lower section 322′ and having a cross section smaller than that of the lower section 322′. The bulb head 1′ has an inner surface 11 provided with an internal thread connected to the external thread of the lower section 322′. The upper section 321′ includes a first upper section 3211 opposite to the lower section 322′ and having a cross section smaller than that of the lower section 322′, and a second upper section 3212 disposed between the first upper section 3211 and the lower section 322′ and having a cross section larger than that of the first upper section 3211 but smaller than that of the lower section 322′. The second upper section 3212 is spaced apart from the inner surface 11 of the bulb head 1′. The LED module 4′ includes a flexible circuit board 6 covering the top mounting plate 31 and a portion of the first upper section 3211 of the surrounding wall 32′, and a plurality of LED units mounted on the circuit board 6. The circuit board 6 includes a top wall 61, and a tubular peripheral wall 62 extending downward from the top wall 61. The LED units include a first LED unit 41 mounted on the top wall 61, and a second LED unit 42 having a plurality of spaced-apart LED chips 421 mounted on the peripheral wall 62. Through this configuration, light emitted from the first and second LED units 41, 42 will not be interfered by the circuit board 6. Further, in order for the LED bulb of the present invention to have good light distribution, the power of the first LED unit 41 (e.g., 2.178 w) is higher than the power of the second LED unit 42 (e.g., 1.65 w).

In summary, because the heat dissipation seat 3, 3′ is mounted on the bulb head 1, 1′, a major portion of heat generated from the LED module 4, 4′ can be transmitted from the heat dissipation seat 3, 3′ to the bulb head 1, 1′ and dissipated into the atmosphere, and the remaining portion of the heat can be transmitted through heat radiation to the bulb body 2 and dissipated into the atmosphere. Hence, the present invention has two heat dissipation paths. Further, because the heat dissipation seat 3, 3′ is disposed within the bulb body 2, the problem of the user accidentally touching the heat dissipation seat 3, 3′ and scalding his/her hand can be resolved. Moreover, through the presence of the control circuit unit 5, the brightness of the LED module 4 can be controlled and adjusted. Additionally, by mounting the first and second LED units 41, 42 on the flexible circuit board 6, the LED bulb of the present invention can have good light distribution. Hence, the object of the present invention can be realized.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. An LED bulb, comprising:
a bulb head;
a bulb body mounted on said bulb head;
a heat dissipation seat connected to said bulb head and disposed within said bulb body, said heat dissipation seat defining a receiving space;
a control circuit unit disposed in said receiving space and connected electrically to said bulb head; and
an LED module connected to and disposed externally of said heat dissipation seat and connected electrically to said control circuit unit.

2. The LED bulb of claim 1, wherein said heat dissipation seat includes a top mounting plate, and a surrounding wall connected to and extending downward from said top mounting plate, said top mounting plate and said surrounding wall cooperatively defining said receiving space.

3. LED bulb of claim 2, wherein said LED module is mounted on said top mounting plate.

4. The LED bulb of claim 2, wherein said control circuit unit is attached to an inner surface of said surrounding wall.

5. The LED bulb of claim 2, wherein said surrounding wall has a lower section inserted into said bulb head.

6. The LED bulb of claim 3, wherein said LED module includes a circuit board covering said top mounting plate and a portion of said surrounding wall, and a plurality of LED units mounted on said circuit board.

7. The LED bulb of claim 6, wherein said LED units include a first LED unit disposed on said circuit board above said top mounting plate, and a second LED unit disposed below said first LED unit.

8. The LED bulb of claim 1, wherein said heat dissipation seat is made of aluminum.

9. The LED bulb of claim 8, wherein said heat dissipation seat is a stamped aluminum body.

10. The LED bulb of claim 2, wherein said surrounding wall has a cylindrical stepped structure, and includes an aluminum oxide insulating lower section having an external thread, and an upper section opposite to said lower section and having a cross section smaller than that of said lower section, said bulb head having an inner surface provided with an internal thread connected to said external thread of said lower section of said surrounding wall, said upper section of said surrounding wall being spaced apart from said inner surface of said bulb head.

11. The LED bulb of claim 1, wherein said bulb body includes a top wall, and a surrounding wall having a wide section extending downwardly from said top wall, a narrow section opposite to said top wall, and a shoulder connected between said wide and narrow sections, said bulb body further including a plurality of convection holes formed in and extending through said top wall and said shoulder.
